(19) United States
(12) Patent Application Publication
(10) Pub. No.: US 2023/0236919 A1
(43) Pub. Date: Jul. 27, 2023

(54) METHOD AND SYSTEM FOR IDENTIFYING ROOT CAUSE OF A HARDWARE COMPONENT FAILURE

(71) Applicant: Dell Products L.P., Round Rock, TX (US)

(72) Inventors: Parminder Singh Sethi, Ludhiana (IN); Lakshmi Saroja Nalam, Bangalore (IN); Bing Liu, Tianjin (CN); Avinash Vishwanath, Bangalore (IN)

(21) Appl. No.: 17/582,426

(22) Filed: Jan. 24, 2022

(51) Int. Cl. G06F 11/07

(52) U.S. Cl. CPC G06F 11/079; G06F 11/0751

(57) ABSTRACT

In general, embodiments relate to a method for identifying hardware component failures, comprising: obtaining system logs that show a transition of device states for a device; using a normalization and filtering module to process and extract relevant data from the system logs and important keywords for the device; creating a device state path for the device from a healthy device state to an unhealthy device state using the extracted relevant data; obtaining the device state path for the device from a storage and a current device state of the device; predicting a next device state of the device based on the current device state using an analysis module; generating a device state chain using the device state path, current device state, and next device state; and identifying root cause of a hardware component failure using the device state chain.

### BACKGROUND

Once computing systems are deployed, customers of these computing systems often encounter failures with the operation of these computing systems. The customers typically try to solve these failures internally, but when they cannot resolve these failures, they often contact technical support to assist them in solving the failures with their computing systems.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1 shows a diagram of a system in accordance with one or more embodiments of the invention.

FIG. 2.1 shows a diagram of a technical support system (TSS) in accordance with one or more embodiments of the invention.

FIG. 2.2 shows a diagram of a normalization and filtering module and a flowchart about the operation of the normalization and filtering module in accordance with one or more embodiments of the invention.

FIG. 3.1 shows a method to create a device state path for a device from a healthy device state to an unhealthy device state in accordance with one or more embodiments of the invention.

FIG. 3.2 shows a method to predict a next device state of a device in accordance with one or more embodiments of the invention.

FIG. 3.3 shows a method to identify root cause of a hardware component failure in in accordance with one or more embodiments of the invention.

FIG. 3.4 shows a method to obtain and process solution or workaround documents of previous hardware component failures in accordance with one or more embodiments of the invention.

FIG. 3.5 shows a diagram of a shared storage in accordance with one or more embodiments of the invention.

FIG. 3.6 shows a method to provide an exact or the most relevant solution for a hardware component failure in accordance with one or more embodiments of the invention.

FIG. 4 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

In general, embodiments of the invention relate to a method and system for identifying root cause of a hardware component failure using a device state chain, and providing an exact or the most relevant solution for the hardware component failure. More specifically, various embodiments of the invention create a device state path from a healthy device state to an unhealthy device state. In various embodiments of the invention discussed below, an analysis module is used to predict a next device state based on a current device state. Further, various embodiments of the invention create a device state chain using the device state path, current device state, and next device state. By using the device state chain, the root cause of the hardware component failure can be identified.

Further, in various embodiments of the invention, by analyzing the solution or workaround documents of previous hardware component failures, a shared storage is created. By performing a context-aware search in the shared storage, an exact or the most relevant solution for the hardware component failure is provided.

The following describes various embodiments of the invention.

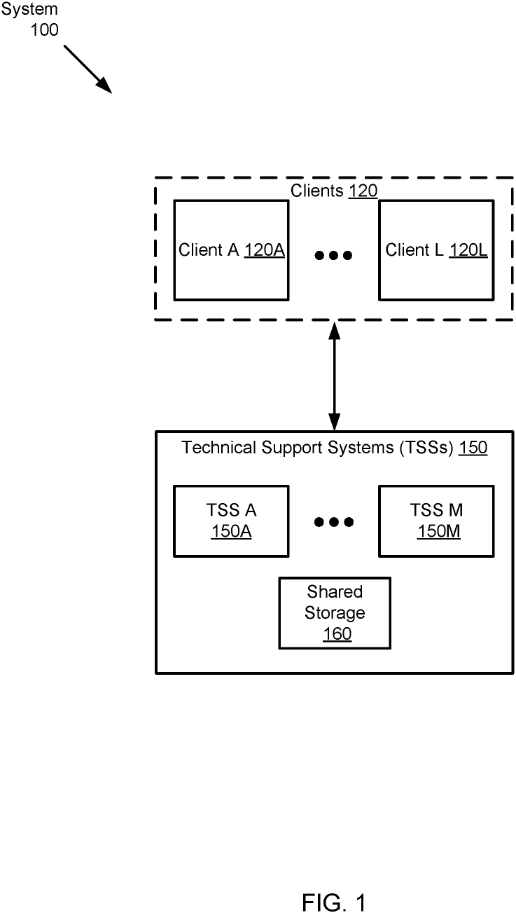

FIG. 1 shows a diagram of a system in accordance with one or more embodiments of the invention. The system includes one or more clients (e.g., client A (120A), client L (120L), etc.) operatively connected to one or more technical support systems (TSSs) (e.g., TSS A (150A), TSS M (150M), etc.) and a shared storage (160).

Each of the TSSs may be operably connected to each other via any combination of wired/wireless connections.

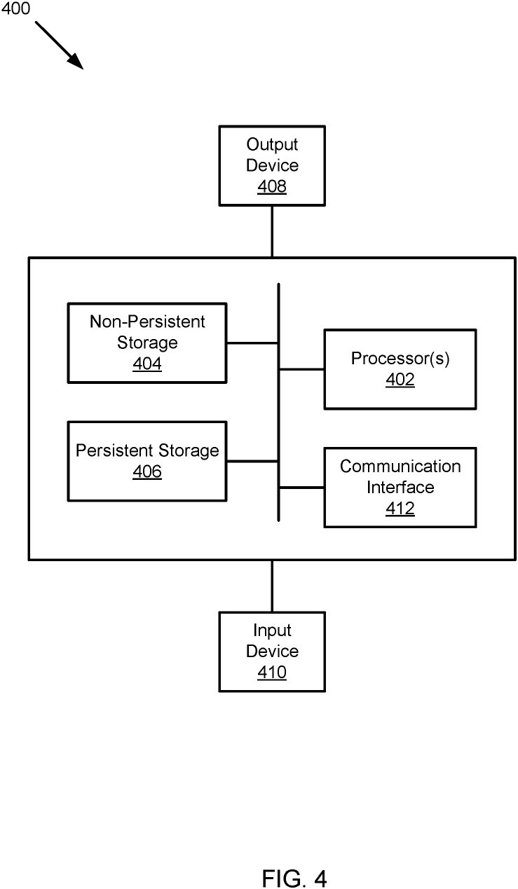

In one or more embodiments of the invention, the clients (120) correspond to devices (which may be physical or logical, as discussed below) that are experiencing failures and that are directly or indirectly connected to the TSSs (150), such that the client device provides logs to the TSS(s) for analysis (as further discussed below). In one or more embodiments of the invention, each client (e.g., 120A, 120L) is implemented as a computing device (see e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device, cause the computing device to perform the functionality of each client (e.g., 120A, 120L) described throughout this application.

In one or more embodiments of the invention, each client (e.g., 120A, 120L) is implemented as a logical device. The logical device may utilize the computing resources of any number of computing devices, and thereby provide the functionality of the client (e.g., 120A, 120L) described throughout this application.

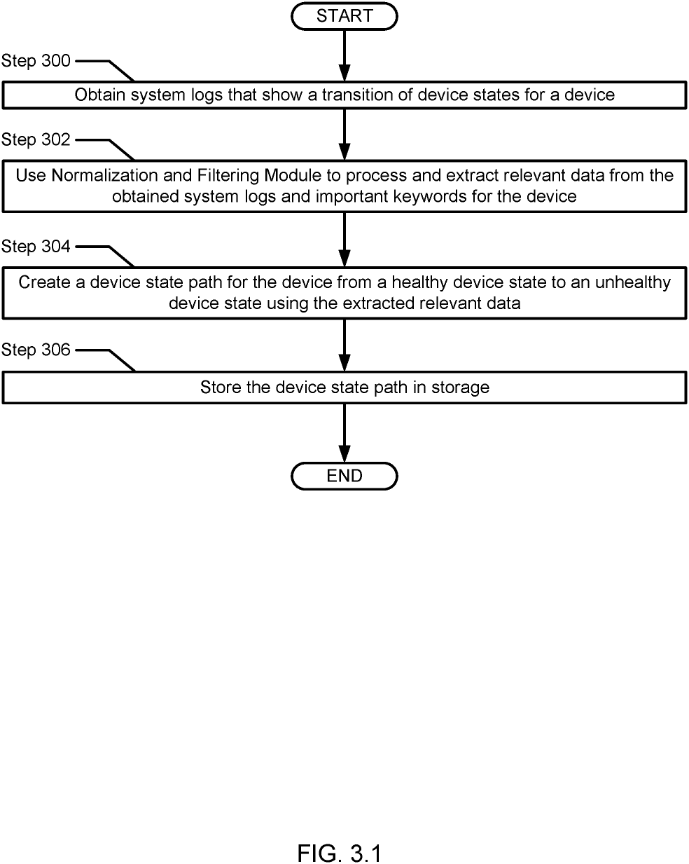

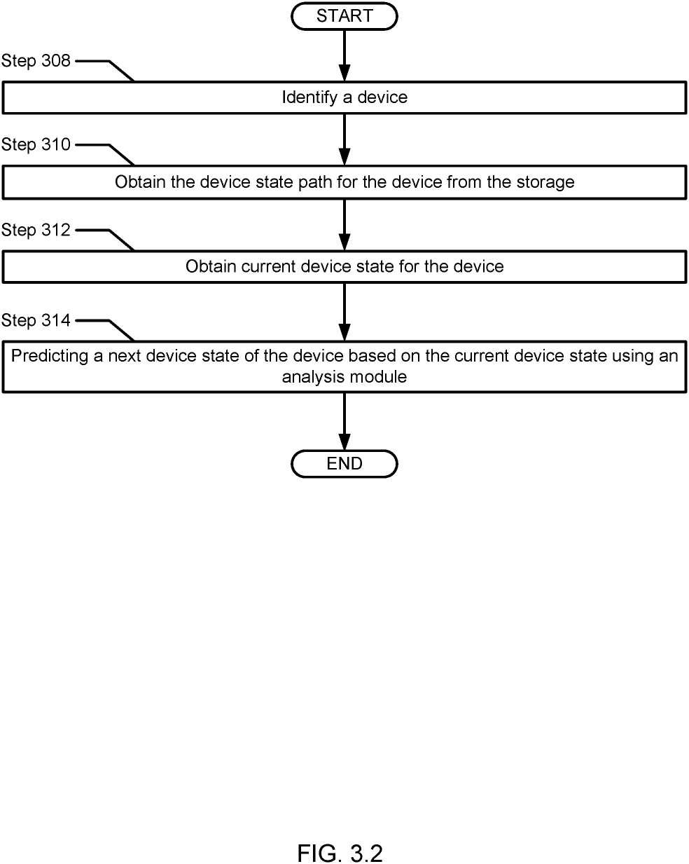

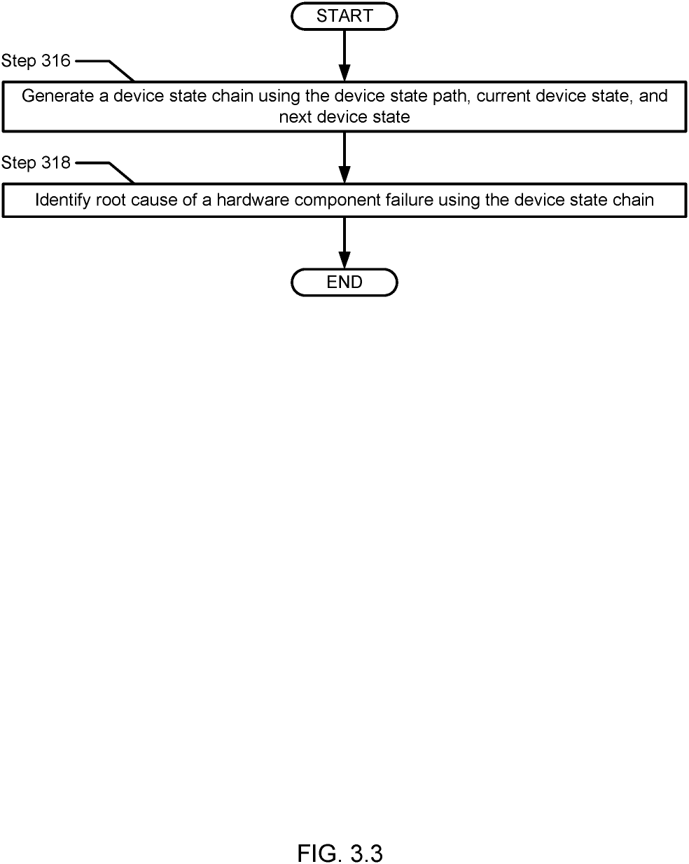

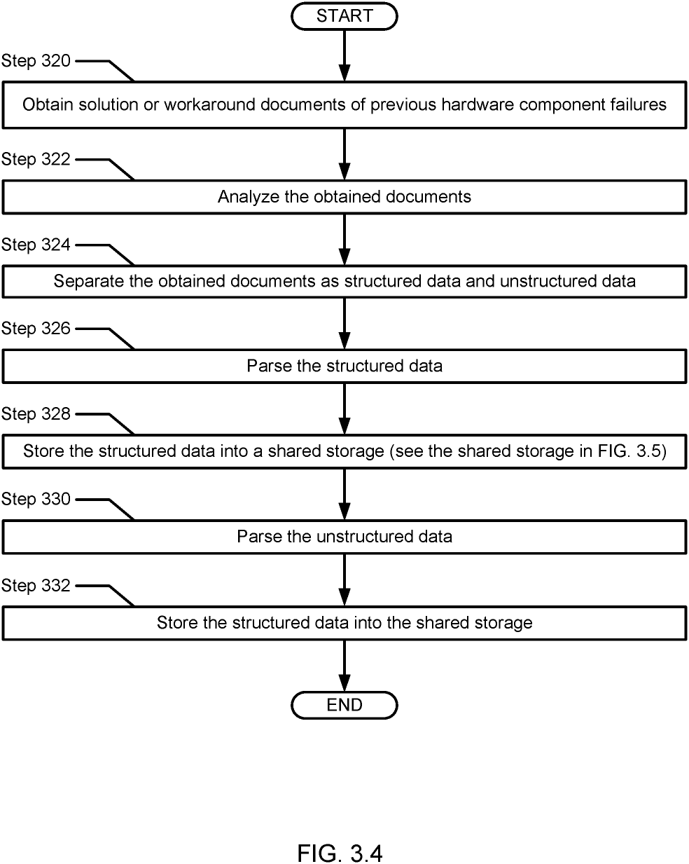

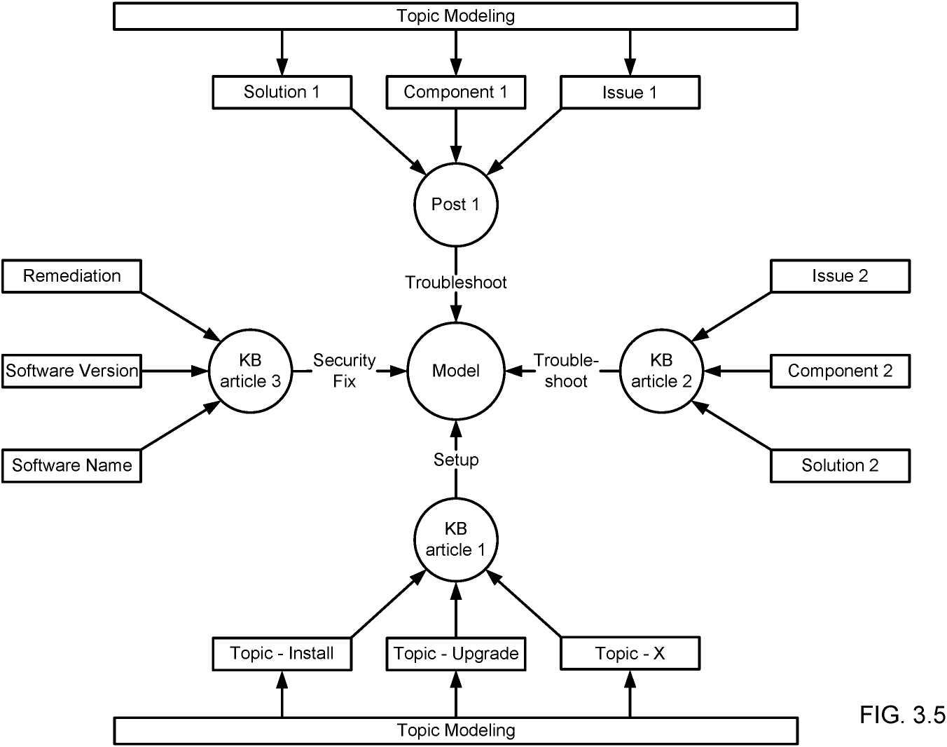

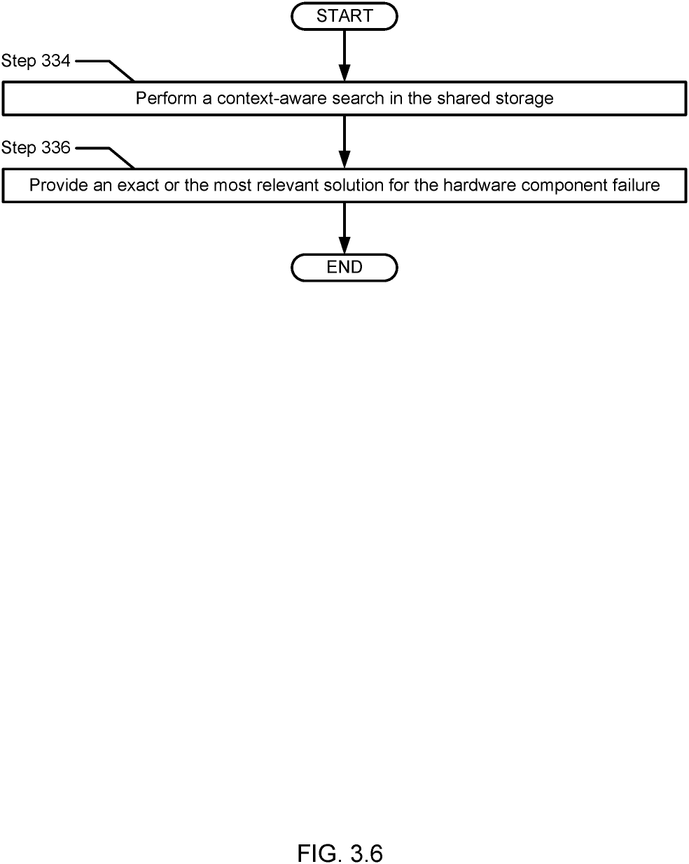

In one or more embodiments of the invention, each of the TSSs (150) is a system to interact with the customers (via the clients (120)) in order to resolve technical support issues. The TSSs (150) provide the functionality of the described throughout this application and/or all, or a portion thereof, of the methods illustrated in FIGS. 3.1-4.

In one or more embodiments of the invention, the TSSs (e.g., 150, 150A, 150M) are implemented as a computing device (see e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, cause the computing device to perform the functionality of the TSSs (150) described throughout this application.

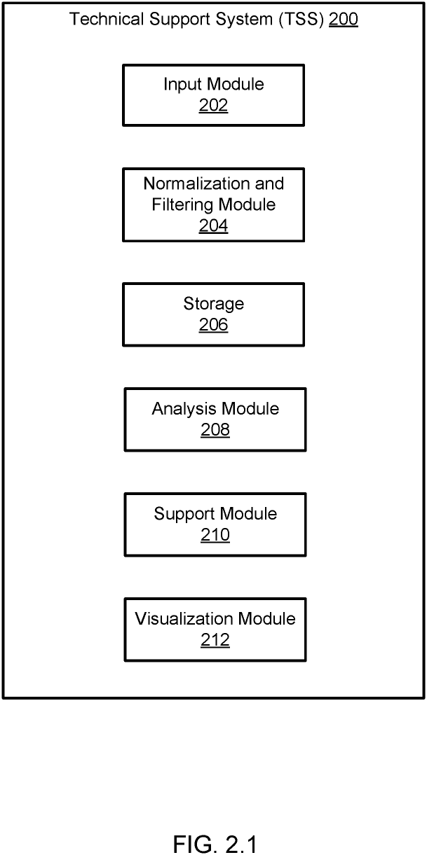

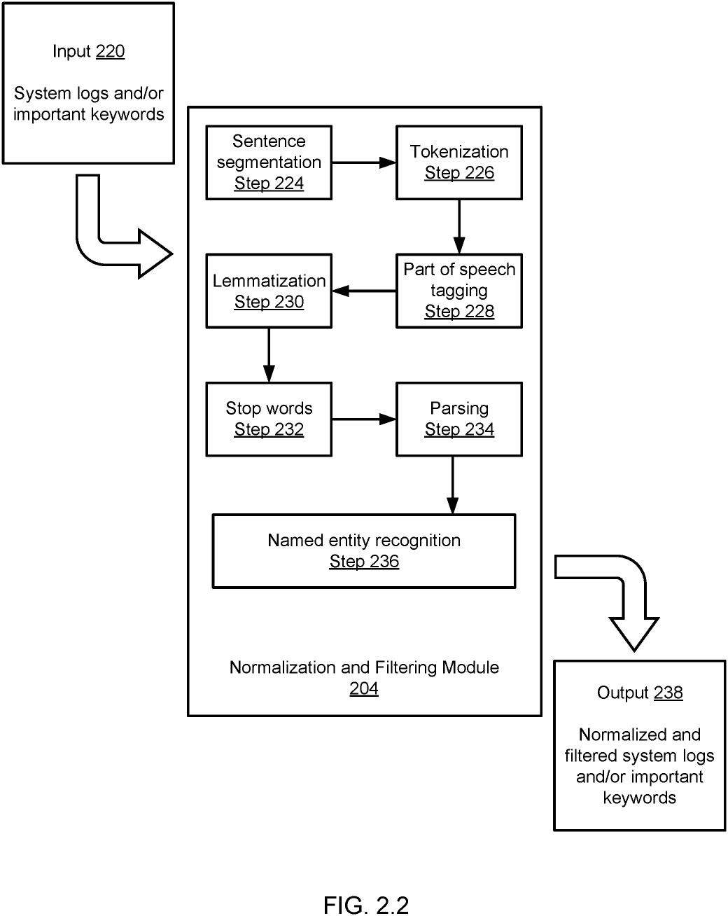

In one or more embodiments of the invention, the TSSs (150) are implemented as a logical device. The logical device may utilize the computing resources of any number of computing devices and thereby provide the functionality of the TSSs (150) described throughout this application. Additional detail about the TSSs (150) are provided in FIGS. 2.1 and 2.2 below.

In one or more embodiments of the invention, the shared storage (160) corresponds to any type of volatile or non-volatile (i.e., persistent) storage device that includes functionality to store unstructured data, structured data, etc.

Turning now to FIG. 2.1, FIG. 2.1 shows a diagram of a technical support system (TSS) in accordance with one or more embodiments of the invention. The TSS (200) includes an input module (202), a normalization and filtering module (204), storage (206), an analysis module (208), a support module (210), and a visualization module (212). Each of these components is described below.

In one or more embodiments of the invention, the input module (202) is any hardware, software, or any combination thereof that includes functionality to obtain system logs (e.g., transition of device states, an alert for medium level of central processing unit (CPU) overheating, etc.) and important keywords for the computing device (e.g., recommended maximum CPU operating temperature is 75° C.) related to the hardware component failure that has occurred on a client device. The input module (202) may include functionality to transmit the obtained system logs and important keywords to the normalization and filtering module (204) as an input.

In one or more embodiments of the invention, the normalization and filtering module (204) processes the input received from the input module (202) and extracts the relevant data. Additional details for the normalization and filtering module (204) are provided in FIG. 2.2.

In one or more embodiments of the invention, the storage (206) corresponds to any type of volatile or non-volatile (i.e., persistent) storage device that includes functionality to store extracted relevant data by the normalization and filtering module (204). In various embodiments of the invention, the storage (206) may also store a device state path (see FIG. 3.1.

In one or more embodiments of the invention, the analysis module (208) is configured to predict a next device state of a device based on a current device state of the device. The analysis module (208) may be implemented using hardware, software, or any combination thereof. Additional detail about the analysis module (208) is provided below.

In one or more embodiments of the invention, the support module (210) is configured to obtain solution or workaround documents for previous hardware component failures. The support module (210) may include functionality to analyze the obtained documents and to store them into the shared storage (e.g., 160, FIG. 1). Based on a context-aware search performed in the shared storage (e.g., 160, FIG. 1), the support module provides an exact or the most relevant solution for the hardware component failure. The support module (210) may be implemented using hardware, software, or any combination thereof.

In one or more embodiments of the invention, the visualization module (212) may include functionality to generate visualizations of methods illustrated in FIGS. 3.1-3.4 and 3.6. The visualization module (212) may be implemented using hardware, software, or any combination thereof.

Turning now to FIG. 2.2, FIG. 2.2 shows a diagram of a normalization and filtering module and a flowchart about the operation of the normalization and filtering module in accordance with one or more embodiments of the invention. For the sake of brevity, not all components of the normalization and filtering module may be illustrated in FIG. 2.2. In one or more embodiments of the invention, the normalization and filtering module (204) may obtain the system logs and important keywords for the computing device from the input module (e.g., 202, FIG. 2) as an input (220). The operation of the normalization and filtering module (204) is explained below.

In Step 224, the input (e.g., Washington, D.C., is the capital of the United States of America. It is also home to iconic museums.) is broken into separate sentences (e.g., Washington, D.C., is the capital of the United States of America.).

In Step 226, tokenization (e.g., splitting a sentence into smaller portions, such as individual words and/or terms) of important elements of a targeted sentence and the extraction of a token (i.e., keyword) based on the identified group of words occurs. For example, based on Step 224, the input is breaking into the smaller portions as “Washington”, “D”, “.”, “C”, “.”, “,”, “is”, “the”, “capital”, “of”, “the”, “United”, “States”, “of”, “America”, “.”.

In Step 228, a part of speech (e.g., noun, adjective, verb, etc.) of each token will be determined. In one or more embodiments of the invention, understanding the part of speech of each token will be helpful to figure out the details of the sentence. In one or more embodiments of the invention, in order to perform the part of speech tagging, for example, a pre-trained part of the speech classification model can be implemented. The pre-trained part of speech classification model attempts to determine the part of speech of each token based on similar words identified before. For example, the pre-trained part of speech classification model may consider “Washington” as a noun and “is” as a verb.

In Step 230, following the part of speech tagging step, a lemmatization (i.e., identifying the most basic form of each word in a sentence) of each token is performed. In one or more embodiments of the invention, each token may appear in different forms (e.g., capital, capitals, etc.). With the help of lemmatization, the pre-trained part of speech classification model will understand that “capital” and “capitals” are originated from the same word. In one or more embodiments of the invention, lemmatization may be implemented according to a look-up table of lemma forms of words based on their part of speech.

Those skilled in the art will appreciate that while the example discussed in Step 230 considers “capital” and “capitals” to implement the lemmatization, any other word may be used to implement the lemmatization without departing from the invention.

In Step 232, some of the words in the input (e.g., Washington, D.C., is the capital of the United States of America.) will be flagged and filtered before performing a statistical analysis. In one or more embodiments of the invention, some words (e.g., a, the, and, etc.) may appear more frequently than other words in the input and while performing the statistical analysis, they may create a noise. In one or more embodiments of the invention, these words will be tagged as stop words and they may identified based on a list of known stop words.

Those skilled in the art will appreciate that while the example discussed in Step 232 uses “a”, “the”, “and” as the stop words, any other stop word may be considered to perform flag and filter operation in the statistical analysis without departing from the invention.

Continuing the discussion of FIG. 2.2., in Step 234, a process of determining the syntactic structure of a sentence (i.e., a parsing process) is performed. In one or more embodiments of the invention, the parsing process may determine how all the words in a sentence relate to each other by creating a parse tree. The parse tree assigns a single parent word to each word in the sentence, in which the root of the parse tree will be the main verb in the sentence. In addition to assigning the single parent word to each word, the parsing process can also determine the type of relationship between those two words. For example, in the following sentence, “Washington, D.C., is the capital of the United States of America”, the parse tree shows “Washington” as the noun and it has a “be” relationship with “capital”.

In Step 236, following the parsing process, a named entity recognition process is performed. In one or more embodiments of the invention, some of the nouns in the input (e.g., Washington, D.C., is the capital of the United States of America.) may present real things. For example, “Washington” and “America” represent physical places. In this manner, a list of real things included in the input may be detected and extracted. In one or more embodiments of the invention, to do that, the named entity recognition process applies a statistical analysis such that it can distinguish “George Washington”, the person, and “Washington”, the place, using context clues.

Those skilled in the art will appreciate that while the example discussed in Step 236 uses physical location as a context clue for the named entity recognition process, any other context clues (e.g., names of events, product names, dates and times, etc.) may be considered to perform the named entity recognition process without departing from the invention.

Following Step 236, the processed input (220) is extracted as normalized and filtered system logs of the device and/or the important keywords for the computing device as an output (238). In one or more embodiments of the invention, the output (238) may be stored in the storage (e.g., 206, FIG. 2.1).

Turning now to FIG. 3.1, FIG. 3.1 shows a method to create a device state path for a device from a healthy device state to an unhealthy device state in accordance with one or more embodiments of the invention. The method shown in FIG. 3.1 may be performed by, for example, a cooperation of the input module (e.g., 202, FIG. 2.1), the normalized and filtering module (e.g., 204, FIG. 2.1), and the storage (e.g., 206, FIG. 2.1).

While FIG. 3.1 is illustrated as a series of steps, any of the steps may be omitted, performed in a different order, additional steps may be included, and/or any or all of the steps may be performed in a parallel and/or partially overlapping manner without departing from the invention.

In Step 300, system logs that show a transition of device states for a device are obtained. In one or more embodiments of the invention, the system logs that show the transition of device states for the device can be obtained from the input module (e.g., 202, FIG. 2.1).

In Step 302, using the normalization and filtering module (e.g., 204, FIG. 2.1), relevant data from the obtained system logs and important keywords for the device are processed and extracted. In one or more embodiments of the invention, the important keywords for the device are selected by a vendor of the device (also referred to as a computing device), by a technical support specialist, by another individual or entity, or any combination thereof. The important key words may be specific technical terms or vendor specific terms that are used in the system log files.

In Step 304, in one or more embodiments of the invention, when a hardware component failure (e.g., fan failure) is reported, using the extracted relevant data, a device state path from a healthy device state to an unhealthy device state is created. In one or more embodiments of the invention, creating the device state path from a healthy device state to an unhealthy device state is useful to understand how the hardware component failure has occurred. In one embodiment of the invention there may be a strong correlation between the device state path and a root cause of the hardware component failure.

In one embodiment of the invention, the processed input is analyzed to identify the various states that a device was in and the transition between these states. The result of this analysis is the generation of a device state path(s) from healthy device state to an unhealthy device state. In this context, a healthy device state corresponds to a device state in which the device is operating as expected; while an unhealthy device state is a device state in which the device is operating outside its expected operating parameters (which may be defined, e.g., by the vendor, a user of the device, any other entity, or any combination thereof).

In Step 306, the created device state path is stored in storage (e.g., 206, FIG. 2.1). In one or more embodiments of the invention, one or more device state paths may be stored in the storage. For example, all the device state paths corresponding to a specific device and/or all the device state paths for all the devices may be stored in the storage.

The method ends following Step 306.

Turning now to FIG. 3.2, FIG. 3.2 shows a method to predict a next device state of a device in accordance with one or more embodiments of the invention. In one or more embodiments of the invention, the next device state of the device is predicted based on a current device state of the device using the analysis module (e.g., 208, FIG. 2.1).

While FIG. 3.2 is illustrated as a series of steps, any of the steps may be omitted, performed in a different order, additional steps may be included, and/or any or all of the steps may be performed in a parallel and/or partially overlapping manner without departing from the invention.

In Step 308, to be able to find the device state path related to the hardware component failure, a device is identified. In one or more embodiments of the invention, the device is the device that has the hardware component failure.

In Step 310, following the Step 308, the device state path for the device is obtained from the storage (e.g., 206, FIG. 2.1). In addition, the information of the hardware components, which reported the hardware component failure, the type of the hardware component failure, and the severity of the hardware component failure are recorded. For example, device 1 reports a critical printed circuit board failure. The type of the failure is recorded as aging of battery and the device state path for the device 1 is obtained as printed circuit board failure→system crash. In another example, device2 reports a critical fan failure. The type of the failure is recorded as dust and the device state path for the device2 is obtained as fan failure→overheating of CPU→CPU failure→system crash.

In Step 312, a current device state of the device is obtained. In one or more embodiments of the invention, the current device state of the device can be obtained automatically at periodic intervals and/or when manually requested by the customer. Additionally, application logs (e.g., warnings, errors, etc. occurred in a software component) that are stored during various device operations may be obtained to further understand the device states before and after those device operations. When the hardware component failure is reported, a support ticket is created and the application logs are uploaded to the TSSs (e.g., 150, FIG. 1).

In one or more embodiments of the invention, based on the data obtained and/or recorded in Steps 310 and 312, the current device state of the device and the device state path of the device are known.

In Step 314, a next device state of the device is predicted using the analysis module (e.g., 208, FIG. 2.1), where the analysis module uses a Markov chain model. In one or more embodiments of the invention, the next device state is predicted based on the current device state of the device (i.e., the device state where the hardware component failure was reported). Further, the analysis module includes a list of device states where the device transitioned and, among the list of device states, the next device state that has the highest probability to become the next device state.

The following is a non-limiting example of the operation of the Markov chain model. The example is not intended to limit the scope of the invention. Turning to the example, at t0, a fan failure (device state S1) alert is generated for a device3. The device state path for the device3 shows that the fan failure caused the following events in order: (i) fan failure, (ii) overheating of CPU (device state S2), (iii) CPU failure, and (iv) system crash (device state S5). At t0, another fan failure alert is generated for a device4. The device state path for device4 shows that the fan failure caused the following events in order: (i) fan failure and (ii) 10% degradation in device4′s performance (device state S3).

Continuing the discussion of the above example, at t1, another fan failure alert is generated for a device5. The device state path for the device5 shows that the fan failure caused the following events in order: (i) fan failure and (ii) 10% degradation in device5′s performance. Next, at t1, another fan failure alert is reported for the device3. The device state path for the device3 shows that the fan failure caused the following events in order: (i) fan failure, (ii) memory module failure (device state S4), and (iii) system crash.

Further, at t2, another fan failure alert is reported for the device4. The device state path for the device4 shows that the fan failure caused the following events in order: (i) fan failure, (ii) overheating of CPU, and (iii) storage device failure (device state S6). Next, at t3, another fan failure alert is reported for the device5. The device state path for the device5 shows that the fan failure caused the following events in order: (i) fan failure and (ii) 10% degradation in device5’s performance.

At t4, another fan failure alert is reported for the device3. The device state path for the device3 shows that the fan failure caused the following events in order: (i) fan failure and (ii) system crash. At t5, another fan failure alert is generated for the device4. The device state path for the device4 shows that the fan failure caused the following events in order: (i) fan failure and (ii) 10% degradation in device4′s performance. Next, at t6, another fan failure alert is generated for the device5. The device state path for the device5 shows that the fan failure caused the following events in order: (i) fan failure, (ii) storage device failure, (iii) virtual disk storage failure, and (iv) system crash. Further, at t6, another fan failure alert is generated for the device5. The device state path for the device5 shows that the fan failure caused the following events in order: (i) fan failure, (ii) storage device failure, and (iii) system crash.

Continuing the discussion of the example, in one or more embodiments of the invention, a transition count of S1 to subsequent states (e.g., S1-S6) are: (i) S1→S1 is zero, (ii) S1→S2 is two, (iii) S1→S3 is four, (iv) S1→S4 is one, (v) S1→S5 is one, and (vi) S1→S6 is two.

In one or more embodiments of the invention, the probability of S1→S2 may be defined as S12/S1, in which the S1 is S11 + S12 + S13 + S14 + S15 + S16. Based on the transition count of S1 to subsequent states, the following probabilities are be obtained: (i) S12/S1 is 0.2, S13/S1 is 0.4, S14/S1 is 0.1, S15/S1 is 0.1, and S16/S1 is 0.2.

Based on the above, the following probabilities for the next state are determined: the probability of overheating of CPU (e.g., the current device state)→CPU failure (e.g., the next device state) is 0.3, the probability of overheating of CPU→storage device failure is 0.1, the probability of overheating of CPU→virtual disk storage failure is 0.2, and the probability of overheating of CPU→printed circuit board failure is 0.2.

Those skilled in the art will appreciate that while the prediction of the next device state of the device is performed by using the Markov chain model, any other analysis model may be used to predict the next device state of the device without departing from the invention.

The method ends following Step 314.

Turning now to FIG. 3.3, FIG. 3.3 shows a method to identify root cause of a hardware component failure in accordance with one or more embodiments of the invention. In one or more embodiments of the invention, the identification of the root cause of the hardware component failure is performed by the support module (e.g., 210, FIG. 2.1).

While FIG. 3.3 is illustrated as a series of steps, any of the steps may be omitted, performed in a different order, additional steps may be included, and/or any or all of the steps may be performed in a parallel and/or partially overlapping manner without departing from the invention.

In Step 316, to be able to provide solutions for the hardware component failure, a device state chain is created using the device state path (which corresponds to the devices states up to the current device state), current device state, and next device state. In one or more embodiments of the invention, while creating the device state chain, not just the previous device is considered, but the whole device state path is considered.

For example, when a hardware component failure (e.g., CPU failure, memory module failure) has occurred, to be able to create the device state chain, the device state path (e.g., including a previous device state (device state A)) is obtained from the storage (e.g., 206, FIG. 2.1) and the next device state (e.g., device state C) is predicted by the Markov chain model.

In one or more embodiments of the invention, the device state chain can be created as A→B (where B is the current state of the device) and B→C, where A represents the fan failure, B represents the overheating of CPU, and C represents the CPU failure. The probability of A→B in the device state chain can be calculated as 0.2 by performing the Markov chain model in reverse. The probability of B→C in the device state chain can be calculated as 0.3 by performing the Markov chain model. Overall, for this example, the probability of the device state chain can be calculated as 0.06.

In another example, the device state chain can be created as A→B and B→E (e.g., another probable next device state), where A represents the fan failure, B represents the overheating of CPU, and E represents the storage device failure. The probability of A→B in the device state chain can be calculated as 0.2 by performing the Markov chain model in reverse. The probability of B→E in the device state chain can be calculated as 0.1 by performing the Markov chain model. Overall, for this example, the probability of the device state chain can be calculated as 0.02.

In Step 318, root cause of the hardware component failure is identified using the device state chain created in Step 316. In one or more embodiment of the invention, the identification of the root cause is performed by the support module (e.g., 210, FIG. 2.1). In one or more embodiments of the invention, for the two device state chain examples above, to identify the root cause of the hardware component failure, the A→B→C device state chain can be considered to provide solutions, because the probability of A→B→C device state chain in terms of the root cause of the hardware component failure is higher than the probability of A→B→E device state chain.

In one or more embodiments of the invention, for the two device state chain examples above, the TSS may receive tickets regarding the CPU failure due to overheating of CPU and/or regarding the memory module failure due to high temperature within the system. The device state chains for these hardware component failures may be different, but these failures arose because of the same root cause (e.g., fan failure). Because the device state chain probability of A→B→C is higher than the device state chain probability of A→B→E, the solutions related to A→B→C will be provided by the support module (e.g., 210, FIG. 2.1).

In one or more embodiments of the invention, when the present device state is B, the device state chain (i.e., A→B→C) (as opposed to the specific hardware failure) is used to searching for solutions for the similar hardware component failures occurred before in the shared storage (e.g., 160, FIG. 1). This approach may provide more in-depth information regarding the root cause of the hardware component failure, because considering only the problematic device state may be not sufficient to identify the root cause.

Said another way, in the aforementioned example, if the fan stopped working in a system, it may be the case that support team was notified that the CPU reported an overheating issue and in other scenarios, they might be notified that the hard disk drive (HDD) error issue is reported due to the high temperature within the system. The sequence of device state transitions may differ, but the issues are of similar type (of the same root cause) (i.e., fan failure). Because the device state transition probability of A to B to C is the highest with 0.06, the troubleshooting steps related to these transitions are tagged with priority and the resolution steps are provided in accordance to the device transition.

The method ends following Step 318.

Turning now to FIG. 3.4, FIG. 3.4 shows a method to obtain and process solution or workaround documents of previous hardware component failures in accordance with one or more embodiments of the invention. In one or more embodiments of the invention, the solution or workaround documents of the previous hardware component failures are obtained and processed by the support module (e.g., 210, FIG. 2.1).

While FIG. 3.4 is illustrated as a series of steps, any of the steps may be omitted, performed in a different order, additional steps may be included, and/or any or all of the steps may be performed in a parallel and/or partially overlapping manner without departing from the invention.

In Step 320, the solution or workaround documents of previous hardware component failures are obtained. In one or more embodiments of the invention, the support module (e.g., 210, FIG. 2.1) is obtained these documents from the corresponding vendor. The obtained documents may include existing knowledge base (KB) articles, device user guides, device release notes, TSS logs, videos, and/or community forum questions and answers.

Those skilled in the art will appreciate that while the obtained documents are described as KB articles, device user guides, device release notes, TSS logs, videos, and/or community forum questions and answers example, any other document may be available in the obtained documents without departing from the invention.

In Step 322, the obtained documents are analyzed by the support module (e.g., 210, FIG. 2.1). In one or more embodiments of the invention, the obtained documents are analyzed as unstructured data and structured data. In one or more embodiments of the invention, the provided solution for the hardware component failure may include the unstructured data, the structured data, or a combination of both.

In Step 324, the obtained documents are separated as unstructured data and structured data. In one or more embodiments of the invention, obtained documents are separated by the support module (e.g., 210, FIG. 2.1) and the support module may use a pre-trained analysis and/or classification model to perform the separation. In one or more embodiment of the invention, the structured data may include several components and/or sections that are structured.

In Step 326, the structured data is parsed. In one or more embodiments of the invention, the structured data is parsed based on the content and/or category of the structured data. For example, the structured data may include security, advisory, solution, etc. categories. Some of the structured data under the solution category may be related to a specific device model. In this manner, the provided solution based on this structured data may only be associated to that specific device model.

In Step 328, following the Step 326, the structured data is stored into the shared storage (e.g., 160, FIG. 1).

Continuing the discussion of FIG. 3.4, in Step 330, the unstructured data is parsed. In one or more embodiments of the invention, the unstructured data is parsed based on a software version, specific device attributes, etc. to find relevant a solution(s). In one or more embodiment of the invention, a pre-trained analysis and/or classification approach (e.g., topic modeling) may be used to parse the unstructured data. Further, the provided solution based on the unstructured data may not only be associated to a specific device model.

In one or more embodiment of the invention, the topic modeling approach (e.g., latent Dirichlet allocation) may use specific tags (e.g., software version, specific device attributes, etc.) to filter and extract the relevant data from the unstructured data. In this manner, a targeted text for a particular solution in the unstructured data may be filtered.

In one or more embodiments of the invention, the unstructured data may be used to assist the structured data. For example, a website link related to a solution provided based on structured data may be obtained from the unstructured data.

In Step 332, the unstructured data is stored into the shared storage (e.g., 160, FIG. 1).

The method ends following Step 332.

Turning now to FIG. 3.5, FIG. 3.5 shows a diagram of a shared storage in accordance with one or more embodiments of the invention. In one or more embodiments of the invention, the shared storage may include one or more KB articles (e.g., KB article 1, KB article 2, KB article 3, etc.), one or more posts (e.g., post 1) posted by the customers. In one or more embodiments of the invention, the KB articles (e.g., “how does CPU overheat impact memory module?”, “How slow speed of the fan have an impact on memory module”, etc.) may include remediation, software version, and component, etc. information for the previous hardware component failures. In an embodiment of the invention shown in FIG. 3.5, the shared storage includes both the unstructured data (e.g., topic – install, topic – upgrade, etc.) and structured data (e.g., security fix, setup, etc.).

Turning now to FIG. 3.6, FIG. 3.6 shows a method to provide an exact or the most relevant solution for a hardware component failure in accordance with one or more embodiments of the invention. In one or more embodiments of the invention, the exact or the most relevant solution for the hardware component failure is provided by the support module (e.g., 210, FIG. 2.1).

While FIG. 3.6 is illustrated as a series of steps, any of the steps may be omitted, performed in a different order, additional steps may be included, and/or any or all of the steps may be performed in a parallel and/or partially overlapping manner without departing from the invention.

In Step 334, a context-aware search for the hardware component failure is performed in the shared storage (e.g., 160, FIG. 1). In one or more embodiments of the invention, the context-aware search (e.g., a search based on the context provided by a user) may be performed by the TSSs (e.g., 150, FIG. 1) or the customer. For example, the customer can perform a context-aware search as “troubleshooting document for a fan failure” or the TSSs can perform a context-aware search as “ticket solution and troubleshooting document for a memory module failure”.

In Step 336, an exact or the most relevant solution for the hardware component failure is provided. In one or more embodiments of the invention, in response to the above context-aware searches, the customer or the TSS will receive a solution(s) considering the highest probability device state chain related to the hardware component failure. For example, if a fan stopped working in a system, the support team may provide solution(s) for overheating of CPU and/or memory module failure due to the high temperature within the system. The sequence of device state transitions may differ, but the issues are of similar type (of the same root cause) (i.e., fan failure). When the support team determines the device state chain of each provided solution and probability associated with each device state chain, the support team may provide the solution(s) with the highest device state transition probability for the hardware component failure.

If the context-aware search query has never been received before, the support module (e.g., 210, FIG. 2.1) will provide the most relevant solution (including the device state chains for the solution) that has the most occurrences of the searched terms.

The method ends following Step 336.

Turning now to FIG. 4, FIG. 4 shows a diagram of a computing device in accordance with one or more embodiments of the invention.

In one or more embodiments of the invention, the computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), an input device(s) (410), an output device(s) (408), and numerous other elements (not shown) and functionalities. Each of these components is described below.

In one or more embodiments, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN), such as the Internet, mobile network, or any other type of network) and/or to another device, such as another computing device.

In one or more embodiments, the computing device (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

The problems discussed above should be understood as being examples of problems solved by embodiments described herein, and the various embodiments should not be limited to solving the same/similar problems. The disclosed embodiments are broadly applicable to address a range of problems beyond those discussed herein.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for identifying hardware component failures, the method comprising:
using a normalization and filtering module to process and extract relevant data from system logs and important keywords for a device;
creating a device state path for the device from a healthy device state to an unhealthy device state using the extracted relevant data;
predicting a next device state of the device based on the current device state using an analysis module;
generating a device state chain using the device state path, current device state, and next device state; and
identifying root cause of a hardware component failure using the device state chain.

2. The method of claim 1, further comprising:
obtaining the system logs, wherein the system logs specify a transition of device states for the device.

3. The method of claim 1, wherein the analysis module comprises a list of device states wherein the device has previously transitioned.

4. The method of claim 3, wherein the next device state has the highest probability to become the next device state among the list of device states.

5. The method of claim 1, wherein the current device state is the device state where the hardware component failure was reported.

6. The method of claim 1, wherein the important keywords for the device are selected by a vendor.

7. The method of claim 1, wherein the analysis module uses a Markov chain model.

8. A non-transitory computer readable medium comprising computer readable program code, which when executed by a computer processor enables the computer processor to perform a method for identifying hardware component failures, the method comprising:
using a normalization and filtering module to process and extract relevant data from system logs and important keywords for a device;
creating a device state path for the device from a healthy device state to an unhealthy device state using the extracted relevant data;
predicting a next device state of the device based on the current device state using an analysis module;
generating a device state chain using the device state path, current device state, and next device state; and
identifying root cause of a hardware component failure using the device state chain.

9. The non-transitory computer readable medium of claim 8, wherein the method further comprises:
obtaining the system logs, wherein the system logs specify a transition of device states for the device.

10. The non-transitory computer readable medium of claim 8, wherein the analysis module comprises a list of device states wherein the device has previously transitioned.

11. The non-transitory computer readable medium of claim 10, wherein the next device state has the highest probability to become the next device state among the list of device states.

12. The non-transitory computer readable medium of claim 8, wherein the current device state is the device state where the hardware component failure was reported.

13. The non-transitory computer readable medium of claim 8, wherein the important keywords for the device are selected by a vendor.

14. The non-transitory computer readable medium of claim 8, wherein the analysis module uses a Markov chain model.

15. A system for identifying hardware component failures, the system comprising:
a processor comprising circuitry;
memory; and
a source node operatively connected to a data domain, executing on the processor and using the memory, and configured to:
use a normalization and filtering module to process and extract relevant data from system logs and important keywords for a device;
create a device state path for the device from a healthy device state to an unhealthy device state using the extracted relevant data;
predict a next device state of the device based on the current device state using an analysis module;
generate a device state chain using the device state path, current device state, and next device state; and
identify root cause of a hardware component failure using the device state chain.

16. The system of claim 15, wherein the analysis module comprises a list of device states wherein the device has previously transitioned.

17. The system of claim 16, wherein the next device state has the highest probability to become the next device state among the list of device states.

18. The system of claim 15, wherein the current device state is the device state where the hardware component failure was reported.

19. The system of claim 15, wherein the important keywords for the device are selected by a vendor.

20. The system of claim 15, wherein the analysis module uses a Markov chain model.
